(19) United States
(12) Patent Application Publication
(10) Pub. No.: US 2007/0106555 A1
(43) Pub. Date: May 10, 2007

(54) Optimum pricing system and method for advertisements on a webpage

(75) Inventor: Eric Benson, Laguna Hills, CA (US)

Correspondence Address: CROCKETT & CROCKETT, 24012 CALLE DE LA PLATA, SUITE 400, LAGUNA HILLS, CA, 92653, US

(73) Assignee: RLI Credit Data, Inc.

(21) Appl. No.: 11/269,450

(22) Filed: Nov. 7, 2005

(51) Int. Cl. G06Q 30/00; G06F 17/00

(52) U.S. Cl. 705/14; 705/400

(57) ABSTRACT

A method and system for determining the optimal cost-per-click a website provider may charge for graphical objects on a first webpage based on an initial event at a first website, a subsequent event at second webpage and an event fee. The graphical objects might include, for instance, advertisements on a webpage, and an initial event may include a consumer clicking on that ad.

### FIELD OF THE INVENTIONS

The inventions described below relate to the field of Internet advertising and more specifically, to a method and system for optimum pricing and revenue generation from placement of graphical objects such as advertisements or topic tiles on a webpage.

### BACKGROUND OF THE INVENTIONS

The Internet provides an inexpensive and convenient medium for information providers to make information available to consumers, businesses and other Internet users on a website. Information in such websites might include, for example, loan information, applications, product specifications, news, movie reviews and stock quotations. While password protected pay-sites exist on the Internet, websites can generally be accessed at no cost to the consumer. Freely accessible websites present a problem regarding revenue generation for providing a website full of information. Some website providers are funded to distribute various information to the public, while other providers use their website as a store front to sell products. Since there are many costs inherent in creating, providing, and maintaining a website, the generation of revenue from a website is important.

In response to such concerns, website providers continue to look for efficient ways to generate more advertising revenue. The advertisements (or ads) appear as banners, blocks, or tiles on various portions on the webpage. Typically, an advertisement serves as a click-through point to sources of more information about that particular advertiser or topic. Advertisements can exist as graphical objects that have a link to other information. The consumer selects the object by clicking on it with a computer pointing device. The selection of the object invokes the link and this action is often referred to as “click-through.”

One method of selling advertising on the Internet is by charging the advertiser a discrete amount for each click-through that occurs on a particular ad. This method is referred to as a cost-per-click, or CPC. Such pricing structures attract more attention from advertisers because the advertiser is only required to pay when the ad attracts click-through traffic. However, this pricing scheme typically requires the CPC to be determined without the website provider knowing the amount of potential revenue generated for the advertiser by the website provider. As such, the website provider may not be charging an optimal amount for his cost-per-click rate when a consumer clicks upon an ad.

An industry where advertising is not receiving an optimal CPC is the mortgage loan industry. Mortgage lenders are willing to purchase leads relating to potential clients from third parties. This information can be found in documents including new home mortgage loan applications, home equity loan applications, refinance loan applications and debt consolidation load applications. Mortgage lenders are willing to pay different amounts depending on the type of document generated. However, due to the Real Estate Settlement Protection Act, many website providers cannot charge advertising rates based on the number and type of loan applications generated through their website because they are not authorized licensed mortgage lenders. As a result, these website providers obtain consumer information for other purposes such as estimating credit scores and display an object linking their website to a an authorized mortgage lender's webpage. A consumer will then complete a loan application or indicate interest in a loan on the authorized mortgage lender's webpage. Presently, the website provider can only charge a flat CPC rate without knowing the number and type of loan applications generated at the mortgage lender's site.

Accordingly, a method and system are needed that will increase the revenue generated by an event occurring for an object which is presented on a page. In the Internet context, a method and system are needed that will allow the website provider to charge an optimal amount an advertiser is willing to pay for click-through traffic on ads presented on a webpage, and thereby increase the revenue generated by a website provider which sells ads on that webpage.

### SUMMARY

The optimum pricing system provides a method and system for determining the optimal cost-per-click a website provider may charge for graphical objects on a first webpage based on an initial event at the first website, a subsequent event at a second webpage and an event fee for the events occurring at a second webpage. The graphical objects might include, for instance, advertisements on a webpage, and an initial event may include a consumer clicking on that ad. The page includes positions for receipt of the object material. Data regarding the past performance of the objects is stored and updated as new data is received. A consumer requests a page from a server associated with system. The server uses the performance data to derive a cost-per-click for the objects on the page. The server performs a calculation regarding the cost-per-click based on actions or events performed by previous consumers, actions or events performed by a current consumer, from actions or events performed by consumers at third party websites subsequent to an initial click-through event and fees associated with events performed by consumers at third party websites subsequent to an initial click-through event.

As applied in context to an Internet based system, the optimum pricing system utilizes a unique system of gathering and grouping information about each particular consumer to the system, and then uses this information to optimize revenue generated for the initial event, or click-through traffic, for a particular graphical object, such as an ad or set of ads, presented to that consumer. Optimization is achieved by calculating an up-to-date cost-per-click for a particular ad based upon sorted and categorized information about previous and current consumers, subsequent events occurring at an advertisers website and a unique event fee. This up-to-date CPC will comprise, in part, actions taken by a consumer subsequent to an initial event and the amount of fees an advertiser is willing to pay for the consumer's click-through. The revenue for the website provider will be significantly increased, as each click-through by a consumer can affect the amount a website provider can charge an advertiser on a cost-per-click basis. Depending on a consumer's actions following an initial click through, an advertiser may be willing to pay varying amounts for the advertising.

As a consumer interacts with various Internet sites, a file of information about a consumer can be generated. The optimum pricing system includes providing a website which gathers and utilizes such information while generating and maintaining a centralized database of information relating to each consumer. If a consumer is new to the site, then the consumer is directed to areas where information about that consumer can be gathered. As the consumer proceeds through various website areas relating to topics such estimated credit scores and estimated credit ratings, information such as age, income, outstanding balances, lines of credit, zip codes and loans of interest can be gathered and stored for each particular consumer under a consumer identification (ID) number. The data from the consumers is then analyzed, delineated, and placed in different groupings or bins for transfer to third party website and servers. Depending on the information type desired by advertisers, website providers can charge advertisers varying costs per event.

The optimum pricing system uses an ad server which queries the system for information about each particular consumer. The groupings of information are used to calculate a click-through-rate for each of the various ads available, based upon an analytical method which includes, among other things, the number of initial click-throughs to an advertiser's website, parameters relating to the consumer's subsequent events at an advertiser's website, event fees associated with subsequent events and the prior performance information for a particular ad.

Advertisers can bid on cost-per-click on rates in websites in the system in exchange for information gathered on the advertiser's website during a discrete time period. A cost-per-click estimation is calculated which will allow convergence toward the true cost-per-click rate by subsequent click-throughs, consumer events occurring after the click-through and the willingness of advertisers to pay for those events. The performance calculation for each ad along with its cost-per-click are used to determine placement of the ads on a website for optimum cost-per-click and generation of revenue.

The optimum pricing system includes an ad performance interface which allows an advertising client to access various ad performance information for a given time period from an ad performance database. Ad performance includes information relating to the number of click-throughs for a given time period, the success of each click-through for each ad and current cost-per-click rates for a particular object. Another interface is provided for competing advertisers to view ad performance information and bid for advertising space and information obtained from consumers in subsequent time periods.

In use, the optimum pricing system is provided with a webpage requested by a consumer. The webpage comprises positions for placement of graphical objects. Each object has associated with it a link to other information, and a certain initial event will invoke that link. Certain performance data is stored regarding the occurrence of events for objects in the system. The performance data is used to calculate a cost-per-click for each object when the event occurs for that particular consumer.

### BRIEF DESCRIPTION OF THE DRAWINGS

FIG. 1 illustrates a generalized layout of a prior art webpage.

FIG. 2 illustrates a layout of a webpage in the optimum pricing system.

FIG. 3 shows a block diagram of the optimum pricing system.

FIG. 4 illustrates a more detailed block diagram of the ad server.

FIG. 5 illustrates an ad performance interface.

FIG. 6 illustrates a sequence of steps that occurs when the consumer is new to a website in the optimum pricing system.

FIG. 7 illustrates a block diagram of the optimum pricing system in use and a cost-per-click calculation that is performed for each ad.

### DETAILED DESCRIPTION OF THE INVENTIONS

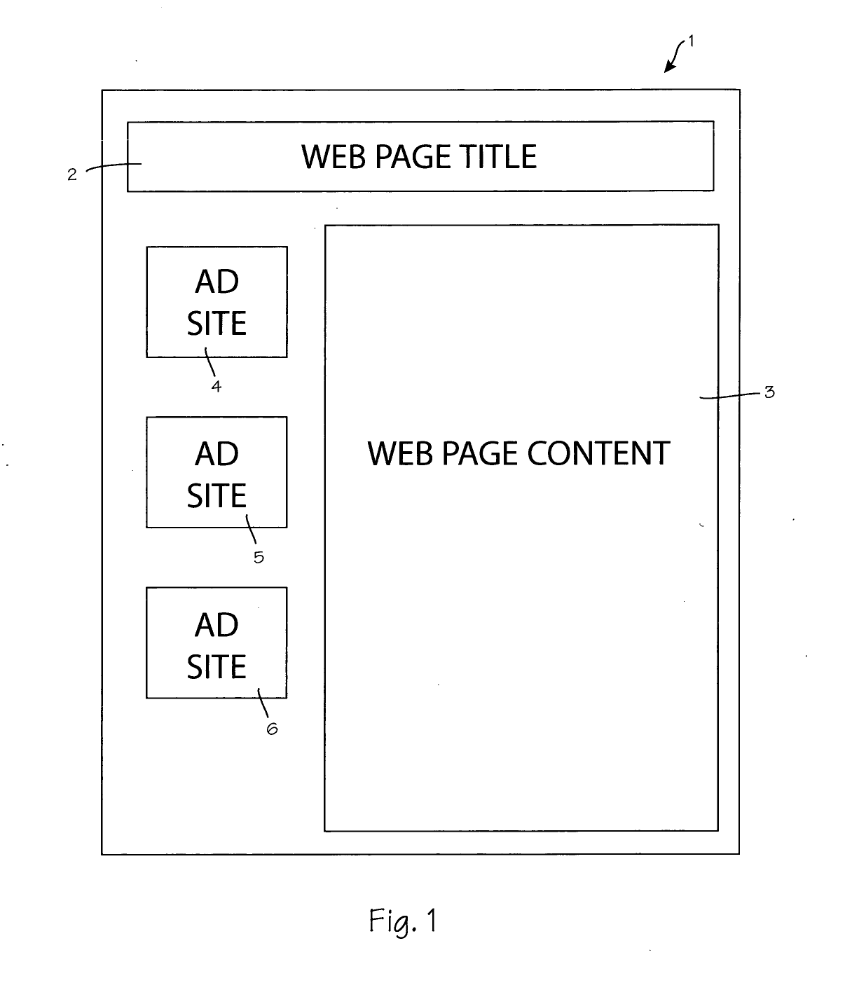

FIG. 1 illustrates a generalized layout of a prior art webpage 1. The webpage contains a webpage title block 2 and a webpage content block 3. A sequence of ad sites 4, 5 and 6 are shown which receive and display ads configured to fit in these spots.

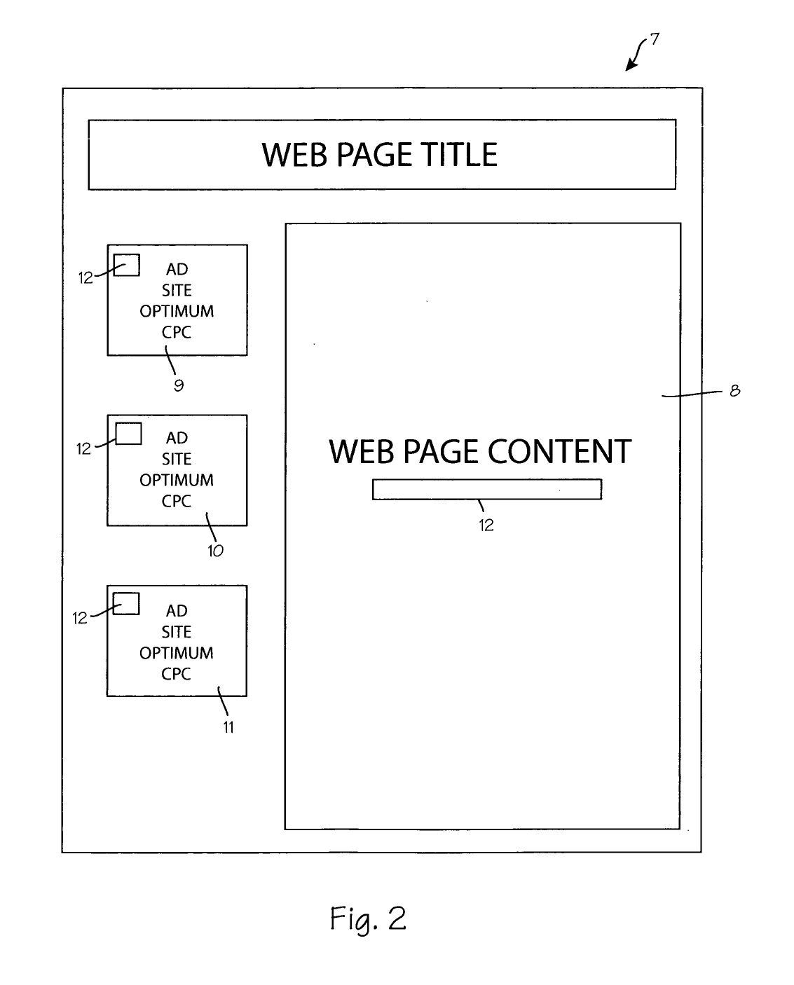

FIG. 2 illustrates a layout of a webpage 7 in the optimum pricing system. The webpage contains a generalized webpage content block 8. A sequence of ad sites 9, 10 and 11 are shown which receive and display ads configured to fit in these spots having the optimum cost-per-click. The ads and/or content block comprise a topic tile having a click-through point 12 or link for more sites and information about a particular topic such as various types of loan applications.

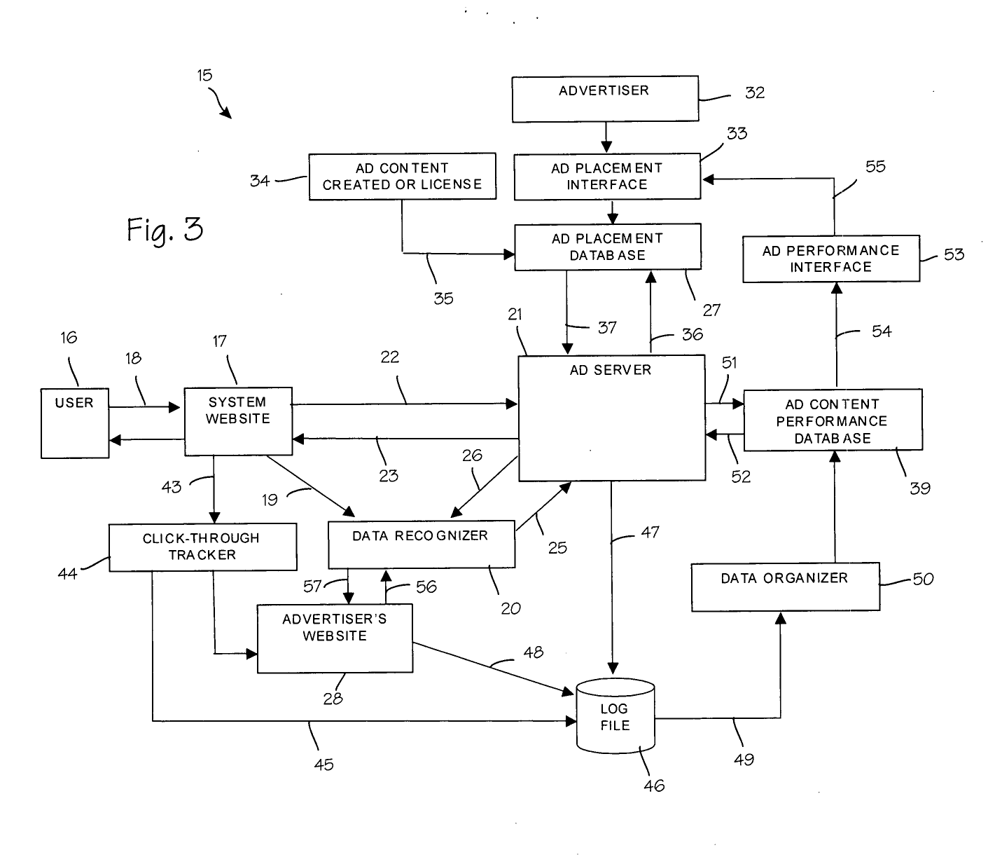

FIG. 3 shows a block diagram of the optimum pricing system 15. The optimum pricing system 15 optimizes the cost-per-click of ads on a webpage in the system. While the elements are discussed in a certain order, many of the processes occur simultaneously or in other order sequences as necessary. In use, a consumer 16 contacts a system's website 17 and requests a webpage 18. During the process of interacting with the website 17, the use 16 will provide personal consumer information 19 such as name, products of interest, salary information, gender and zip code. The consumer information 19 is sent from the web site 17 to a data recognizer 20 used for recognizing certain information about a consumer such as products of interest. A database within the data recognizer is used to store consumer information. The consumer information is accessible through a consumer identification (ID) or tracking number created for each consumer.

When a website 17 wants to display a webpage, it contacts 22 an ad server 21. The ad server indicates which webpage and website will be shown as well as generates the tracking number of the consumer who will view the page. The ad server gathers consumer information relating to the particular consumer and a particular ad or set of ads from authorized websites. The ad server generates and sends 23 a set of ads which have been selected for placement on the system's website based on the information obtained from a consumer, information of interest to a consumer and the optimum amount an advertiser is willing to pay to have his advertisement presented to the consumer and having a consumer perform subsequent events at the advertiser's website.

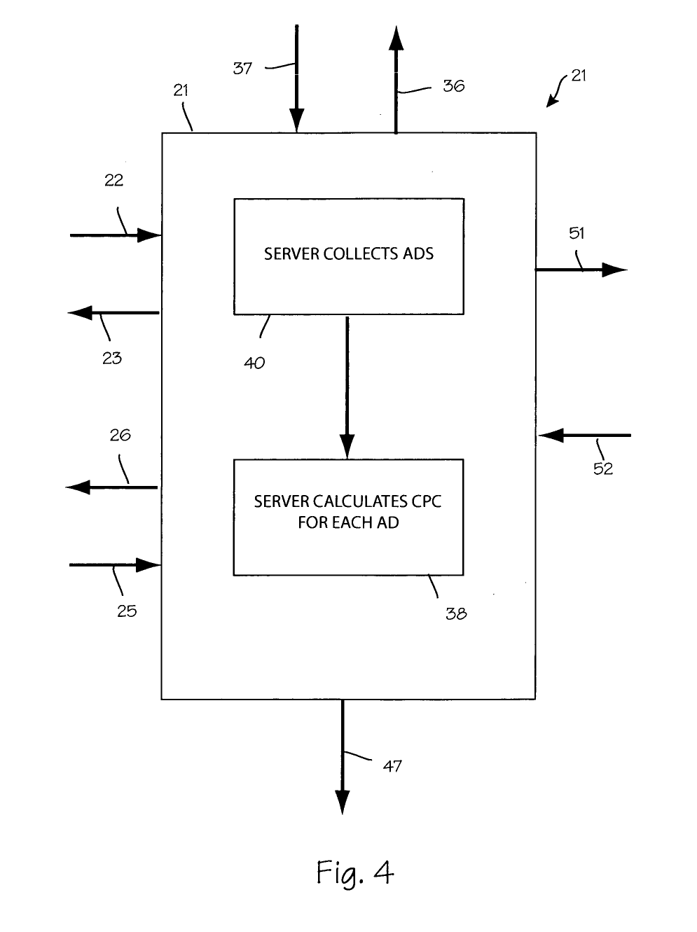

As shown in FIG. 3 and FIG. 4, the ad server will query the data recognizer software and database for information 25 about the particular consumer. The data recognizer then returns the information requested 26 back to the ad server 21 for use in requesting possible ads for placement and determining cost-per-clicks relating to those ads. An ad/content database 27 is provided for storing a plurality of ads used for possible display. The ad/content database 27 may contain information about each ad contract such as cost-per-click-through, constraints on pages or positions where the ad may be placed, and/or constraints on consumer information that must hold for the ad to be presented.

Consumer information or subsequent events at an advertiser's website such as filing out form fields for ordering services or products or selecting other links to additional information may have different values depending on the types of advertisers and the nature of the information or event. In the case of mortgage banking, banks are willing to pay varying amounts for consumer information on loan form fields from consumers interested in different types of loan applications such as home equity loans, home refinance loans, new home loans and debt consolidation loans. Banks may be willing to pay more for consumer information on a consumer interested in a home refinance loan than for information from a consumer interested in a new home loan. As such, the click-through-rate for a banking advertisement and link on a non-banking page can vary depending on the nature of the information later gathered from subsequent events the consumer performs at a third party or advertiser's website 28.

Ads are created and/or purchased by the advertiser 32 who may use an ad placement interface 33 to place ads in the ad placement database 27. The interface 33 is web accessible and would guide the advertiser 32 through the necessary steps for creating and uploading an ad into the database. Alternatively, the general content of the ads is created and/or licensed 34 by administrators of such accounts and entered 35 into the ad/content placement database 27. The ad server 21 requests ads or content material 36 from the ad/content placement database based upon consumer information from the particular consumer and the cost-per-click for the ad. The database then returns the ads 37 for placement on the webpage that fit the particular characteristics or information requested by the consumer and that can charge the optimum cost-per-click for the initial event.

FIG. 4 illustrates a more detailed block diagram of the ad server. With the ads 37 collected for placement 40 on the system's website, the ad server 21 is able to perform a cost-per-click calculation 38 based on initial click-throughs or events originating at a system's website and subsequent actions or events by a consumer at an advertiser's website. This calculation requires access to performance information for each ad. An ad performance database 39 is provided which stores click-through data for each ad such number of initial click-throughs, subsequent events associated with the click-throughs, event fees and success of subsequent events. The ad performance database 39 also stores data concerning the grouping of consumers into different categories or bins. The consumer data and subsequent event data is sampled and bins are created which differentiate consumers and subsequent events in optimal ways for charging optimal click-through rates to advertisers. For example, a bin of all consumers interested in new mortgage loans at an advertiser's website might be created as one separate bin rather than all consumers interested in all types of loans. This strategy for categorizing consumers and subsequent events performed by consumers becomes important when trying to determine costs-per-click as different consumers or subsequent events can be charged different event fees.

When a consumer clicks on a particular ad 43, a click-through tracker 44 is provided to track and then record the initial click-throughs 45 into a log file 46. The log file also collects ad impression data 47 from the ad server 21 as well as subsequent consumer events 48 occurring at an advertiser's website 28 or second website after the initial click-through event at a first system's website 17. The log file outputs the log data 49 into a data organizer 50. The data organizer processes through all the consumer data, and places each bit of consumer data in its appropriate bin. The ad/content performance database 39 is a static database that is updated periodically from the data organizer.

As illustrated in FIG. 3 and FIG. 4, the ad Server 21 sends a request 51 for ad performance and statistical data to the ad/Content performance database 39 and the requested performance statistics 52 are returned to the ad server 21. A cost-per-click is calculated from statistical for each ad based upon the number of click-throughs for a particular ad, subsequent events performed by a consumer at an advertiser's website and an event fee associated with those events.

The website 17 requests ads from the ad Server 21. After the steps previously described have been performed, the ad server 21 delivers a set of ads for display to the consumer that have been optimized for increased revenue generation for the webpage provider.

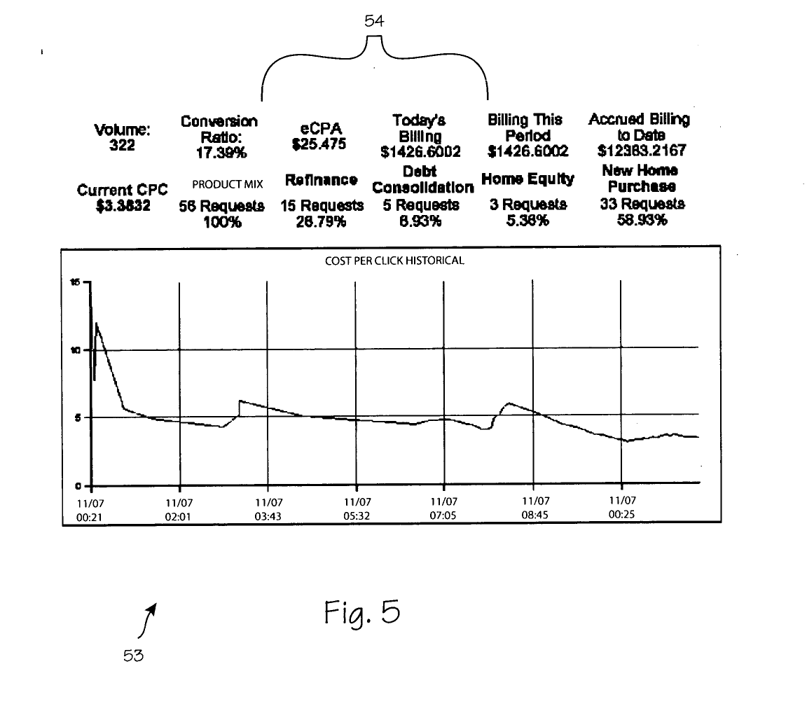

As illustrated in FIG. 3 and FIG. 5, an ad performance interface 53 may be provided allowing the advertiser 32 to monitor and track the performance of their ads. The ad performance interface collects performance statistical data 54 from the ad/content performance database. Ad performance statistical data may include the number of click-throughs for a discrete time period, the number of subsequent events occurring at an advertiser's website after a click-through such as requested loan products, the types of events or product mix occurring at an advertiser's website as a result of the click through, current or historical event fees, and current or historical cost-per-click for each ad. The interface provides consumer-friendly and viewable data 55 to the advertiser including demographic profiles, areas of interest to consumers clicking on the advertiser's ads, number of click-throughs for a discrete time period, the number of subsequent events occurring at an advertiser's website after a click-through, the types of events occurring at an advertiser's website as a result of the click through, current or historical event fees, and current or historical cost-per-click for each ad. Such information can be valuable in targeting future customers with particular ads, establishing event fees or bidding on CPC rates. The information also serves to demonstrate the success rate of the ad.

A tracking number is created for each consumer and provides access to stored information about the consumer within the optimum pricing system. When a site learns a new piece of information about a consumer, such as salary or zip code, this information is sent to the recognizer which enters this information into the centralized database. When a site queries the ad Server for a set of ads to place on a page, the site passes the centralized Id to the ad server, which in turn requests any relevant information associated with that consumer Id from the recognizer database. When a consumer clicks-through an ad and is sent to an advertiser's website, the recognizer database might also be queried 56 by the advertiser's website site 28 or third party server for information about the consumer. This information may be transferred 57 by the recognizer to the advertiser's website 28 or third party server for use with subsequent events. Separate authentication would be provided for read and write access to the Recognizer database.

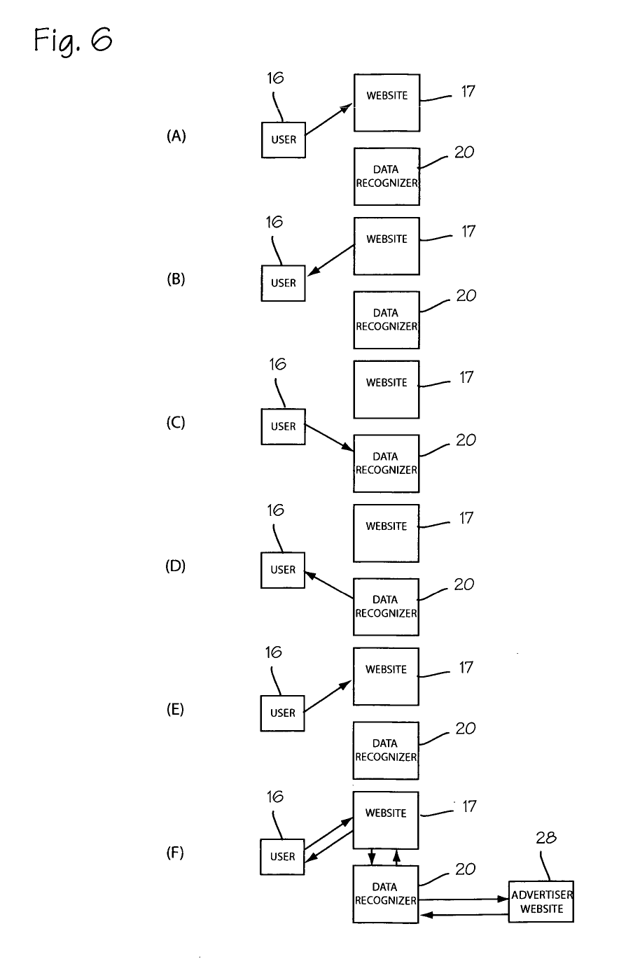

FIG. 6 illustrates a sequence of steps that occurs when the consumer is new to a website 17 in the optimum pricing system 15. In step (a), the consumer 16 requests a webpage 7 from a web server. In step (b), the web server redirects the consumer 16 to the data recognizer 20. In step (c), the consumer 16 requests the URL from the data recognizer 20. In step (d), the data recognizer 20 redirects the consumer 16 to the site with the Id appended. In step (e), the consumer 16 sends a request for the original page desired, but with the Id appended. In step (f), the consumer will interact with the website 17 and the data recognizer 20 will record consumer information 16 from the website 17 for potential transfer to an advertiser's website 28 or third party server.

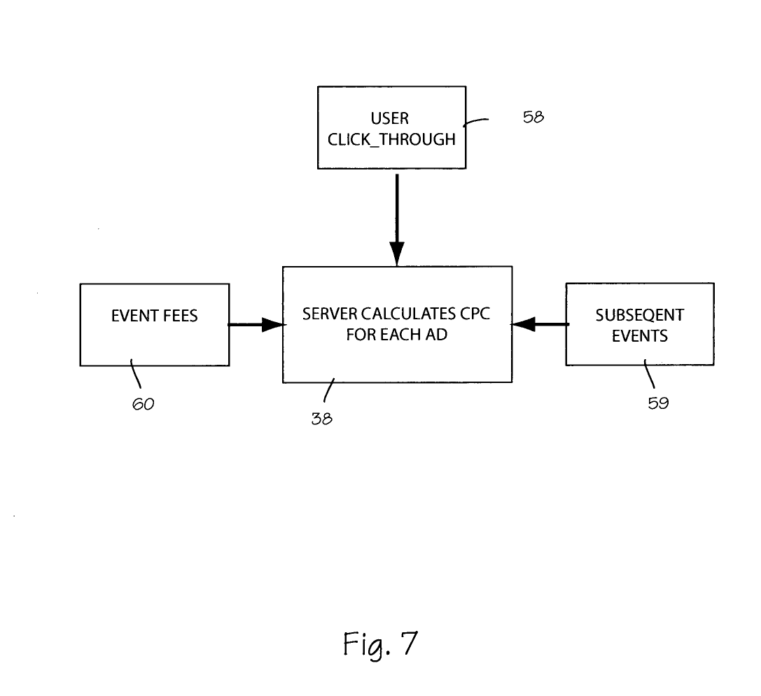

FIG. 7 illustrates a block diagram of the optimum pricing system in use and a cost-per-click calculation that is performed for each ad. When the optimum pricing system is in use, the website will request HTML code from the ad server 21 to place the appropriate advertising blocks in the webpage. The ad server outputs this information to the consumer and the information is decoded and arranged by the consumer's web browser. When the consumer 16 clicks-through 58 or performs an initial event on an ad, they are redirected through the log counter so that the click-through can be counted. After the click-through, the consumer is sent to the URL specified by the advertiser to an advertiser's website 28. While at the advertiser's website 28, a consumer will have the option to perform subsequent events 59 such as clicking on other links, filling out different types of loan applications, requesting information about products and/or services resulting in potential clients or leads for the advertiser or purchase products from the advertiser. A subsequent event occurring at an advertiser's website resulting in part from a consumer's initial click-through from a website in the optimum pricing system, may have varying values to the advertiser. As such, the optimum pricing system can charge an event fee 60 unique to the advertiser and to the subsequent event occurring. This event fee can be used to calculate a cost-per-click rate for the initial event.

The value of placing an ad includes a fixed, known amount of revenue per impression, plus some amount of revenue generated if the ad is clicked on. Since clicking on the an ad is a random event, the ad server determines amount of revenue that results from click-throughs based on the number of actual click-throughs by consumers to an advertiser's website and events performed by a consumer subsequent to his click-through, such events having an event fee associated with the event. The ad server is therefore attempting to maximize the click through rate based on actual value of the click through to an advertiser. The ad server calculates the cost-per-click (CPC) for discrete time periods by taking the total number of events (Eᵢ) occurring at an advertiser's website by a consumer, multiplying the number of events (Eᵢ) by an event fee (Feeᵢ) unique to those types of events and dividing by the total number of click-throughs (CT) occurring for a particular ad for the discrete time period. The cost-per-click rate is calculated by the following formula:

$$( CPC ) = \frac{( {E}_{1} ) \times ( {Fee}_{1} ) + ( {E}_{2} ) \times ( {Fee}_{2} ) + … + ( {E}_{i} ) \times ( {Fee}_{i} )}{CT}$$

For example, in a discrete one hour time period, an ad for a mortgage lender loan information may receive a total of 116 click-throughs (CT). The consumers clicking through the ad during the discrete time period may perform a total of 14 subsequent events including the following: filling out 1 debt consolidation loan application (E₁) having an event fee (Fee₁) of $5.00; filling out 1 home equity loan application (E₂) having an event fee (Fee₂) of $15.00; filling out 10 home purchase loan application (E₃) having an event fee (Fee₃) of $2.00; and filling out 2 home equity loan application (E₄) having an event fee (Fee₄) of $12.00. These subsequent events and event fees result in a calculated CPC for the time period of $0.55. Cost-per-click rates will fluctuate each minute during the one hour period depending on the number of initial events or click-throughs by a consumer to an advertisers website and whether the consumer performs a subsequent event at the advertiser's website.

The system may charge advertisers such as lenders calculated cost-per-click rates at the end of discrete time periods or rates decided through a bidding and auction process. The optimum pricing system can be used to auction cost-per-click rates for discrete future time periods. Since lenders are able to examine data for previous time periods related to click-through rates as well as track events subsequent to click-throughs including applications generated, competing lenders can bid on cost-per-click rates for subsequent time periods in an effort to have their ad placed on a system's website in place of another's ad and to have access to potential consumers.

For example, if a day is divided into one-hour parts and there are 3 lenders in the system bidding on click-through rates, then every hour the advertiser who has placed the highest bid will have his advertisement placed on the website. During a one-hour period, there is a certain number of click-throughs from a system's webpage by consumers such as borrowers selecting a link to a lender's webpage. A lender that has successfully bid for the discrete time period will be billed the cost-per-click rates in his winning bid at the end of the period. The optimum pricing system could display the advertiser's banner in the drop down for products such as Home Loans and/or other types of loan applications. A banner having fields that are specific to that client's account and process can also be displayed. At the end of a discrete time period, the ad server in the optimum pricing system will look for the highest bidder for the next time period, then switch to the advertiser having the highest bid by placing that advertiser's ad into the website.

A reserve price for the optimum pricing system can be established in the auction of cost-per-click rates for discrete future time periods. The reserve price can be set based on the historical average number of clicks from a system website per application event generated at a lender's website. A reserve price for the cost-per-click auction could also be set based on the historical average number of clicks per application event at a lender's website in a predetermined discrete time period immediately preceding the predetermined discrete time period for which lenders are currently bidding. Furthermore, a reserve price could be set based on cost-per-click calculated from a nominal application total fee and the historical average number of clicks per application.

While the preferred embodiments of the devices and methods have been described in reference to the environment in which they were developed, they are merely illustrative of the principles of the inventions. Other embodiments and configurations may be devised without departing from the spirit of the inventions and the scope of the appended claims.

I claim:

1. A method for calculating costs-per-click comprising:
providing a first website having an ad with a click-through tile, said tile capable of performing a click-through when selected by a consumer with a computer pointing device;
recording the number of click-throughs by one or more consumers from the first website for a discrete time period;
recording subsequent events performed by the one or more consumers at a second website during the discrete time period;
charging an event fee corresponding to the events occurring at the second website; and
determining a cost-per-click at the first website based on the number of click-throughs at the first website, the events occurring at the second website and the event fee.

2. The method of claim 1 wherein the ad is an advertisement for a mortgage broker and the subsequent event is completing a field in a loan application selected from the group consisting of a home equity loan, a home refinance loan, a new home loan and a debt consolidation loan.

3. A system for determining cost-per-click of a graphical object on a first page accessible by a consumer, said object having at least one link to a second page, said link being invoked by a first event identifying the object by a computer pointing device, the system comprising:
a device for storing data associated with the past performance of an object;
a device for storing data associated with a subsequent event occurring at the second page; and
a server for determining cost-per-click during a discrete period of time for the object at the first page based on the data associated with the subsequent event occurring at the second page.

4. The system of claim 3 further comprising a device for gathering and storing consumer information.

5. The system of claim 3 wherein the graphical objected is an advertisement for a mortgage broker and the subsequent event is filling out a form field on a loan application.

6. A method of selling advertising on an internet web-page, said method comprising:
operating a website and providing said web site with a web page having content of interest to potential borrowers;
providing a link on the web page, said link being selectively operable to direct the borrower to the site of a lender;
providing a web-based interface for a plurality of prospective lenders to bid to have the link direct the borrower to their own site for a predetermined time period;
selectively operating the web page, during the predetermined time period, such that all borrowers selecting the link are directed to the site of the lender making the highest bid for the link for the predetermined time period;
charging the lender the bid price for each time a prospective borrower selects the link.

7. The method of claim 6, further comprising:
setting a reserve price, said reserve price being set based on the historical average number of clicks per application.

8. The method of claim 6, further comprising:
setting a reserve price, said reserve price being set based on the historical average number of clicks per application in a predetermined time period immediately preceding the predetermined time period for which lenders are currently bidding.

9. The method of claim 6, further comprising:
setting a reserve price, said reserve price being set based on cost-per-click calculated from a nominal application total fee and the historical average number of clicks per application.

10. The method of claim 6, further comprising:
repeatedly accepting bids for a subsequent predetermined time period during a current time period, and changing the lender to whom potential borrowers are directed upon selection of the link depending on the highest bid for each subsequent time period.
